(19) United States
(12) Patent Application Publication
(10) Pub. No.: US 2022/0114412 A1
(43) Pub. Date: Apr. 14, 2022

(54) A SYSTEM AND A METHOD FOR GENERATING A HEAD MOUNTED DEVICE BASED ARTIFICIAL INTELLIGENCE (AI) BOT

(71) Applicant: DIMENSION NXG PRIVATE LIMITED, Thane (IN)

(72) Inventors: Pankaj Uday RAUT, Maharashtra (IN); Abhijit Bhagvan PATIL, Maharashtra (IN); Abhishek TOMAR, Madhya Pradesh (IN)

(21) Appl. No.: 17/419,190

(22) PCT Filed: Dec. 27, 2019
(86) PCT No.: PCT/IB2019/061400

§ 371 Date: Jun. 28, 2021

(30) Foreign Application Priority Data
Dec. 28, 2018 (IN) 201821049698

(51) Int. Cl. G06N 3/00; G06T 19/00; G06V 30/28; G06V 40/16

(52) U.S. Cl. CPC G06N 3/006; G06V 40/171; G06V 30/28; G06T 19/006

(57) ABSTRACT

A method for generating an Artificial Intelligence (AI) bot comprises the steps of receiving (210) information of a human (3102), indicative of the physical characteristics including an appearance and vocals of the human (3102) and behavioural characteristics of the human (3102), analysing (220) the information for identifying and mimicking the vocals of the human (3102), analysing (230) the information for identifying and imitating the appearance of the human (3102), generating (240) the AI bot having the appearance of the human (3102) in a mixed reality space, processing and merging (250) the identified physical characteristics and the behavioural characteristics into the AI bot, displaying (260) the AI bot having physical characteristics and the behavioural characteristics of the human (3102) using the HMD (102), enabling (270) an interaction of the AI bot with users in the mixed reality space, thereby enabling the omnipresence of the human (3102).

### FIELD OF THE INVENTION

Embodiment of the present invention relates to an augmented reality technology and more particularly to a system and a method for generating a head mounted device based Artificial Intelligence (AI) bot capable of analysing and mimicking physical and behavioural traits of a human.

### BACKGROUND OF THE INVENTION

Activities of a human can usually be observed when their manifestation are physically or digitally available. Digital manifestation of a human includes capturing and profiling the visual, acoustic and other multi-sensory data streams into storage devices and thereby invoking it through a medium capable of displaying it within a real-world scenario. The digital presence of a human (deceased or alive) within real time scenarios is a complicated task. It requires the physical manifestation to be either available before a audio-visual data streaming device audio-visual or a pre-recorded stream of its physical manifestation to be present beforehand. The limitation of such an approach is that it provides each recipient with the same audio-visual feed across the space-time domain as has been telecasted. In order to replicate a person's action without the presence of physical being over a pre-recorded or real-time digital stream, knowledge about the attributes related to its physical and behavioural identities of a person needs to be learnt. With the evolution of artificial intelligence over the past few decades, the task of learning the physical and behavioural lifestyle of a person in terms of mathematical attributes seems feasible. Modelling the person's behavioural pattern through artificial intelligence into a virtual agent ensures that it can act and imitate the physical and behavioural traits of the person in all cases evident to absence of real-time physical manifestation of the person. Existence of such an invention becomes viable in all such situations where telepresence of individual humans portraying different set of actions and behaviour across different spaces at same instance of time is desired.

Existing methods lack a methodology towards human telepresence at same timestamp over different locations as per the need of the recipient. For example, if a representation has to be made of a deceased person, the existing solutions fails to elevate human visual perception towards sensing the presence of a human through augmented reality interfaces. Existence of such methods of representation of human beings through augmented or virtual reality interfaces may help in educational institutions and workplaces. Such solutions do not allow humans to virtually place and augment themselves before anyone within real-time scenarios.

Hence, there exists a need for a system and a method for generating an HMD based artificial intelligence (AI) bot capable of analysing and mimicking physical and behavioural traits of a human that does not suffer from above-mentioned deficiencies and provide an effective and viable solution.

### OBJECT OF THE INVENTION

An object of the present invention is to provide a system for generating a head mounted device based artificial intelligence (AI) bot within a mixed reality environment.

Another object of the present invention is to provide a method for generating a head mounted device based artificial intelligence (AI) bot within a mixed reality environment.

Yet another object of the present invention is to develop an HMD based mixed reality system capable of leveraging artificial intelligence towards creating an agent imitating physical and behavioural traits of alive/deceased human beings.

Yet another object of the present invention is to create a virtual clone of the human capable of imitating his physical and behaviour traits within real-time scenarios.

Yet another object of the present invention is to generate multiple digital manifestation of humans present at same instant of time across different recipients situated at different locations around the globe.

### SUMMARY OF THE INVENTION

The present invention is described hereinafter by various embodiments. This invention may, however, be embodied in many different forms and should not be construed as limited to the embodiment set forth herein.

According to the first aspect of the present invention, a method for generating an Artificial Intelligence (AI) bot capable of analysing and mimicking human behaviour (dead/alive) using a Mixed Reality (MR) based Head Mounted Device (HMD) is provided. The method comprises of the steps of receiving information of a human, indicative of the one or more physical characteristics including an appearance and vocals of the human and one or more physical and behavioural characteristics of the human, analysing the information for identifying and mimicking the vocals of the human, analysing the information for identifying and imitating the appearance of the human including body pose as well as the one or more behavioural characteristics of the human, generating the AI bot having the appearance of the human in a mixed reality space, processing and merging the identified one or more physical characteristics and the one or more behavioural characteristics into the AI bot, displaying the AI bot having one or more physical characteristics and one or more behavioural characteristics of the human using the HMD, enabling an interaction of the AI bot with one or more users within the mixed reality space, thereby enabling the digital omnipresence of the human. Further, the information is received in the form of an audio, an image, a video, a text document or a combination thereof. In addition, the text document is a printed document and/or handwritten document configured to be analysed using Optical Character Recognition (OCR) for identifying and imitating the one or more physical characteristics and the one or more behavioural characteristics from the text.

In accordance with an embodiment of the present invention, the human can be alive or deceased.

In accordance with an embodiment of the present invention, the one or more physical and behavioural traits of the individual comprise a thought process, reactions in predetermined situations and mannerisms including a way of walking, sitting, sprinting, eating, interaction with people, performance of daily chores and daily life objects.

In accordance with an embodiment of the present invention, the audio information of the human is received in the form of an audiobook, a recorded audio and/or an audio received using one or more microphone of the HMD.

In accordance with an embodiment of the present invention, the video information of the human is received in the form a movie, a recorded video and/or a visual input received using one or more cameras integrated or docked into the HMD.

In accordance with an embodiment of the present invention, the information in the form of text documents are selected from a group comprising a biography, an autobiography, transcripts, handwritten manuscripts and published articles describing the human.

In accordance with an embodiment of the present invention, the step of analysing the information for identifying and imitating the appearance of the human further comprises the steps of identifying a plurality of facial landmarks from a face of the human, a body pose estimation of the human and identifying a plurality of coordinates indicative of movement of the human, thereby capturing the motion of the human.

In accordance with an embodiment of the present invention, if the information of human is insufficient in the form of an audio, an image, a video, a text document or a combination, the AI bot generated is configured to gather additional information of the human from internet.

In accordance with an embodiment of the present invention, the method further comprises a step of detecting and censoring explicit information in the form of the audio, the image, the video, the text document from the internet or user interaction, thereby preventing the AI bot from learning such information or answering user queries involving the explicit information.

In accordance with an embodiment of the present invention, the AI bot generated is configured to learn and teach specific skills and continuously improve the learnt specific skills with time, using the information from the internet based on user feedback and cues.

In accordance with an embodiment of the present invention, the method further comprising a step of predicting the one or more physical and the one or more behavioural characteristics of the human (dead/alive) whose bot has been generated, at different ages of life and incorporate the same in the generated AI bot.

In accordance with an embodiment of the present invention, the method further comprising a step of tweaking of one or more physical characteristics and the one or more behavioural characteristics of the generated AI bot to make the AI bot better than the human whose AI bot has been generated.

In accordance with an embodiment of the present invention, the AI bot generated is configured to learn and interact in one or more languages while keeping the one or more physical characteristics and the one or more behavioural characteristics of the human.

In accordance with an embodiment of the present invention, the AI bot generated is configured with spatial awareness of the one or more objects present in the mixed reality space.

In accordance with an embodiment of the present invention, the AI bot is configured with an emotional intelligence of the human whose AI bot is being generated.

In accordance with an embodiment of the present invention, the AI bot is configured to collect information from various interactions with different users to process it and give a human understandable and organic feedback to the human whose AI bot has been created, thereby helping in the enrichment of the skillset and attributes of the same human.

In accordance with an embodiment of the present invention, the method further comprising a step of implementing data privacy, data ownership and data censorship clauses and procedures to ensure that all the new censored data collected by the AI bot while interacting with multiple users and the capabilities learnt from the interactions is the ownership of the user generating the AI bot.

According to second aspect of the present invention, a computer system for generating an Artificial Intelligence (AI) bot capable of analysing and mimicking human behaviour (dead/alive) using a Mixed Reality (MR) based Head Mounted Device (HMD) is provided. The computer system being connected with the MR based HMD, the computer system comprises a memory unit configured to store machine-readable instructions and a processor operably connected with the memory unit, the processor obtaining the machine-readable instructions from the memory unit, and being configured by the machine-readable instructions to receive information of a human, indicative of the one or more physical characteristics including an appearance and vocals of the human and one or more behavioural characteristics of the human, analyse the information for identifying and mimicking the vocals of the human, analyse the information for identifying and imitating the appearance of the human including body pose as well as the one or more behavioural characteristics of the human, generate the AI bot having the appearance of the human in a mixed reality space, process and merging the identified one or more physical characteristics and the one or more behavioural characteristics into the AI bot, display the AI bot having one or more physical characteristics and the one or more behavioural characteristics of the human using the HMD, enable an interaction of the AI bot with one or more users in the mixed reality space, thereby enabling the omnipresence of the human, wherein the information is received in the form of an audio, an image, a video, a text document or a combination thereof. Additionally, the text document is a printed document and/or handwritten document configured to be analysed using Optical Character Recognition (OCR) for identifying and imitating the one or more physical characteristics and the one or more behavioural characteristics from the text.

In accordance with an embodiment of the present invention, the human is a dead person or an alive person.

In accordance with an embodiment of the present invention, the one or more behavioural characteristics comprise a thought process, reactions in predetermined situations and mannerisms including a way of walking, sitting, sprinting, eating, interaction with people, performance of daily chores and daily life objects.

In accordance with an embodiment of the present invention, the audio information of the human is received in the form of an audiobook, a recorded audio and/or an audio received using one or more microphone of the HMD.

In accordance with an embodiment of the present invention, the video information of the human is received in the form a movie, a recorded video and/or a visual input received using one or more cameras of the HMD.

In accordance with an embodiment of the present invention, the information in the form of text documents are selected from a group comprising a biography, an autobiography, transcripts, handwritten manuscripts and published articles describing the human.

In accordance with an embodiment of the present invention, for analysing the information for identifying and imitating the appearance of the human, the processor is configured to identify a plurality of facial landmarks from a face of the human, estimate a body pose of the human using the body pose estimation and identify a plurality of coordinates indicative of movement of the human, thereby capturing the motion of the human.

In accordance with an embodiment of the present invention, if the information of human is insufficient in the form of an audio, an image, a video, a text document or a combination, the AI bot generated is configured to gather additional information of the human from internet.

In accordance with an embodiment of the present invention, the AI bot generated is configured to adapt changes and improve using the information from the internet and the information in the form of an audio, an image, a video, a text document or a combination thereof.

According to third aspect of the present invention, a system for generating an Artificial Intelligence (AI) bot capable of analysing and mimicking human behaviour (dead/alive) using a Mixed Reality (MR) based Head Mounted Device (HMD) is provided. The system comprises a control module connected with the HMD, an interface module, a voice identification module and a facial and body posture estimation module. Furthermore, the interface module is configured to receive information of a human, indicative of the one or more physical characteristics including an appearance and vocals of the human and one or more behavioural characteristics of the human. Additionally, the voice identification module is configured to analyse the information for identifying and mimicking the vocals of the human. In addition, the facial and body posture estimation module analyse the information for identifying and imitating the appearance of the human including body pose as well as the one or more behavioural characteristics of the human. Moreover, the control module is configured to generate the AI bot having the appearance of the human in a mixed reality space, process and merging the identified one or more physical characteristics and the one or more behavioural characteristics into the AI bot. Further, the HMD is configured to display the AI bot having one or more physical characteristics and the one or more behavioural characteristics of the human using the HMD, enable an interaction of the AI bot with one or more users in the mixed reality space, thereby enabling the omnipresence of the human. Moreover, the information is received in the form of an audio, an image, a video, a text document or a combination thereof. Further, the text document is a printed document and/or handwritten document configured to be analysed using Optical Character Recognition (OCR) for identifying and imitating the one or more physical characteristics and the one or more behavioural characteristics from the text.

In accordance with an embodiment of the present invention, the human is a dead person or an alive person.

In accordance with an embodiment of the present invention, the one or more behavioural characteristics comprise a thought process, reactions in predetermined situations and mannerisms including a way of walking, sitting, sprinting, eating, interaction with people, performance of daily chores and daily life objects.

In accordance with an embodiment of the present invention, the audio information of the human is received in the form of an audiobook, a recorded audio and/or an audio received using one or more microphones of the HMD.

In accordance with an embodiment of the present invention, the video information of the human is received in the form a movie, a recorded video and/or a visual input received using one or more cameras of the HMD.

In accordance with an embodiment of the present invention, the information in the form of text documents are selected from a group comprising a biography, an autobiography, transcripts, handwritten manuscripts and published articles describing the human.

In accordance with an embodiment of the present invention, the facial and body posture estimation module is configured to identify a plurality of facial landmarks from a face of the human, estimate a body pose of the human using the body pose estimation and identify a plurality of coordinates indicative of movement of the human, thereby capturing the motion of the human.

In accordance with an embodiment of the present invention, if the information of human is insufficient in the form of an audio, an image, a video, a text document or a combination, the AI bot generated is configured to gather additional information of the human from internet.

In accordance with an embodiment of the present invention, the AI bot generated is configured to adapt changes and improve using the information from the internet and the information in the form of an audio, an image, a video, a text document or a combination thereof.

According to fourth aspect of the present invention, a method for generating and displaying an Artificial Intelligence (AI) bot capable of analysing and mimicking human behaviour (dead/alive) is provided. The method comprises the steps of receiving information of a human, indicative of the one or more physical characteristics including an appearance and vocals of the human and one or more behavioural characteristics of the human, analysing the information for identifying and mimicking the vocals of the human, analysing the information for identifying and imitating the appearance of the human including body pose as well as the one or more behavioural characteristics of the human, generating the AI bot having the appearance of the human in a mixed reality space, processing and merging the identified one or more physical characteristics and the one or more behavioural characteristics into the AI bot, displaying the AI bot having one or more physical characteristics and the one or more behavioural characteristics of the human on a display means, enabling an interaction of the AI bot with one or more users in the mixed reality space, thereby enabling the omnipresence of the human. In addition, the information is received in the form of an audio, an image, a video, a text document or a combination thereof. Additionally, the text document is a printed document and/or handwritten document configured to be analysed using Optical Character Recognition (OCR) for identifying and imitating the one or more physical characteristics and the one or more behavioural characteristics from the text.

In accordance with an embodiment of the present invention, the human is a dead person or an alive person.

In accordance with an embodiment of the present invention, the one or more behavioural characteristics comprise a thought process, reactions in predetermined situations and mannerisms including a way of walking, sitting, sprinting, eating, interaction with people, performance of daily chores and daily life objects.

In accordance with an embodiment of the present invention, the audio information of the human is received in the form of an audiobook, a recorded audio and/or an audio received using one or more microphone.

In accordance with an embodiment of the present invention, the video information of the human is received in the form a movie, a recorded video and/or a visual input received using one or more cameras.

In accordance with an embodiment of the present invention, the information in the form of text documents are selected from a group comprising a biography, an autobiography, transcripts, handwritten manuscripts and published articles describing the human.

In accordance with an embodiment of the present invention, the step of analysing the information for identifying and imitating the appearance of the human further comprises the steps of identifying a plurality of facial landmarks from a face of the human, a body pose estimation of the human and identifying a plurality of coordinates indicative of movement of the human, thereby capturing the motion of the human.

In accordance with an embodiment of the present invention, the display means is selected from a group comprising a Head Mounted Device (HMD) or a computing means having a display screen such as a laptop, a desktop computer, mobile computer, handheld computer and a holographic display.

According to fifth aspect of the present invention, a computer system for generating and displaying an Artificial Intelligence (AI) bot capable of analysing and mimicking human behaviour (dead/alive) using a display means, the computer system comprises a memory unit configured to store machine-readable instructions and a processor operably connected with the memory unit, the processor obtaining the machine-readable instructions from the memory unit, and being configured by the machine-readable instructions to receive information of a human, indicative of the one or more physical characteristics including an appearance and vocals of the human and one or more behavioural characteristics of the human, analyse the information for identifying and mimicking the vocals of the human, analyse the information for identifying and imitating the appearance of the human including body pose as well as the one or more behavioural characteristics of the human, generate the AI bot having the appearance of the human in a mixed reality space, process and merging the identified one or more physical characteristics and the one or more behavioural characteristics into the AI bot, display the AI bot having one or more physical characteristics and the one or more behavioural characteristics of the human using the display means, enable an interaction of the AI bot with one or more users in the mixed reality space, thereby enabling the omnipresence of the human. Further, the information is received in the form of an audio, an image, a video, a text document or a combination thereof. In addition, the text document is a printed document and/or handwritten document configured to be analysed using Optical Character Recognition (OCR) for identifying and imitating the one or more physical characteristics and the one or more behavioural characteristics from the text.

In accordance with an embodiment of the present invention, the human is a dead person or an alive person.

In accordance with an embodiment of the present invention, the one or more behavioural characteristics comprise a thought process, reactions in predetermined situations and mannerisms including a way of walking, sitting, sprinting, eating, interaction with people, performance of daily chores and daily life objects.

In accordance with an embodiment of the present invention, the audio information of the human is received in the form of an audiobook, a recorded audio and/or an audio received using one or more microphone.

In accordance with an embodiment of the present invention, the video information of the human is received in the form a movie, a recorded video and/or a visual input received using one or more cameras.

In accordance with an embodiment of the present invention, the information in the form of text documents are selected from a group comprising a biography, an autobiography, transcripts, handwritten manuscripts and published articles describing the human.

In accordance with an embodiment of the present invention, for analysing the information for identifying and imitating the appearance of the human, the processor is configured to identify a plurality of facial landmarks from a face of the human, estimate a body pose of the human using the body pose estimation and identify a plurality of coordinates indicative of movement of the human, thereby capturing the motion of the human.

In accordance with an embodiment of the present invention, the display means is selected from a group comprising a Head Mounted Device (HMD) or a computing means having a display screen such as a laptop, a desktop computer, mobile computer, handheld computer and a holographic display.

According to sixth aspect of the present invention, a system for generating and displaying an Artificial Intelligence AI bot capable of analysing and mimicking human behaviour dead/alive is provided. The system comprises a computing device connected with a display means, an interface module, a voice identification module and a facial and body posture estimation module. Further, the interface module is configured to receive information of a human, indicative of the one or more physical characteristics including an appearance and vocals of the human and one or more behavioural characteristics of the human. Additionally, the voice identification module is configured to analyse the information for identifying and mimicking the vocals of the human. Moreover, the facial and body posture estimation module analyse the information for identifying and imitating the appearance of the human including body pose as well as the one or more behavioural characteristics of the human. In addition, the computing device is configured to generate the AI bot having the appearance of the human in a mixed reality space, process and merging the identified one or more physical characteristics and the one or more behavioural characteristics into the AI bot. Additionally, the display means is configured to, display the AI bot having one or more physical characteristics and the one or more behavioural characteristics of the human using the display means, enable an interaction of the AI bot with one or more users in the mixed reality space, thereby enabling the omnipresence of the human. Moreover, the information is received in the form of an audio, an image, a video, a text document or a combination thereof. Further, the text document is a printed document and/or handwritten document configured to be analysed using Optical Character Recognition OCR for identifying and imitating the one or more physical characteristics and the one or more behavioural characteristics from the text.

In accordance with an embodiment of the present invention, the human is a dead person or an alive person.

In accordance with an embodiment of the present invention, the one or more behavioural characteristics comprise a thought process, reactions in predetermined situations and mannerisms including a way of walking, sitting, sprinting, eating, interaction with people, performance of daily chores and daily life objects.

In accordance with an embodiment of the present invention, the audio information of the human is received in the form of an audiobook, a recorded audio and/or an audio received using one or more microphones.

In accordance with an embodiment of the present invention, the video information of the human is received in the form a movie, a recorded video and/or a visual input received using one or more cameras.

In accordance with an embodiment of the present invention, the information in the form of text documents are selected from a group comprising a biography, an autobiography, transcripts, handwritten manuscripts and published articles describing the human.

In accordance with an embodiment of the present invention, for analysing the information for identifying and imitating the appearance of the human, the facial and body posture estimation module is configured to identify a plurality of facial landmarks from a face of the human, estimate a body pose of the human using the body pose estimation and identify a plurality of coordinates indicative of movement of the human, thereby capturing the motion of the human.

In accordance with an embodiment of the present invention, the display means is selected from a group comprising a Head Mounted Device (HMD) or a computing means having a display screen such as a laptop, a desktop computer, mobile computer, handheld computer and a holographic display.

### BRIEF DESCRIPTION OF THE DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments.

These and other features, benefits and advantages of the present invention will become apparent by reference to the following text figure, with like reference numbers referring to like structures across the views, wherein:

FIG. 1 illustrates an exemplary environment of computing devices to which the various embodiments described herein may be implemented, in accordance with an embodiment of the present invention;

FIG. 2 illustrates a method for generating and displaying an Artificial Intelligence (AI), in accordance with an embodiment of the present invention;

FIG. 3 illustrates an information flow diagram of providing an input to the system and processing the input, in accordance with an embodiment of the present invention;

FIG. 4 illustrates an information flow diagram of generating and displaying an AI bot after processing the input, in accordance with an embodiment of the present invention; and

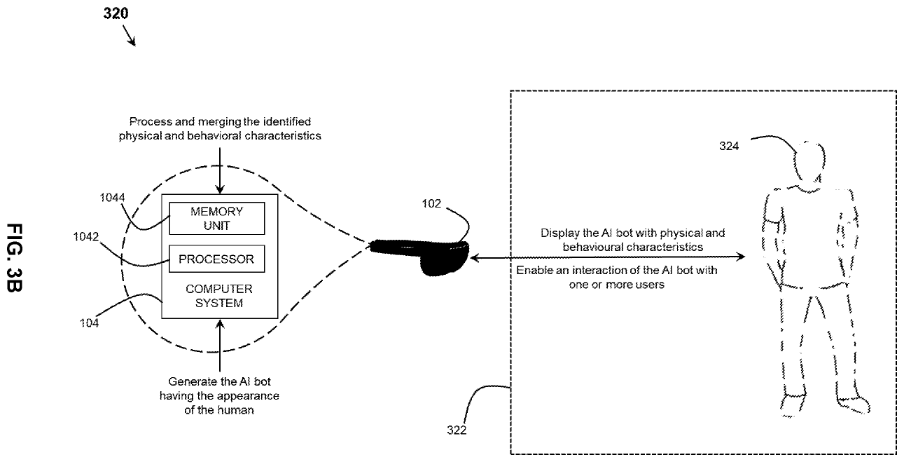

FIG. 5 illustrates a system for generating and displaying an Artificial Intelligence (AI), in accordance with an embodiment of the present invention.

### DETAILED DESCRIPTION OF DRAWINGS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like are included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawings, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

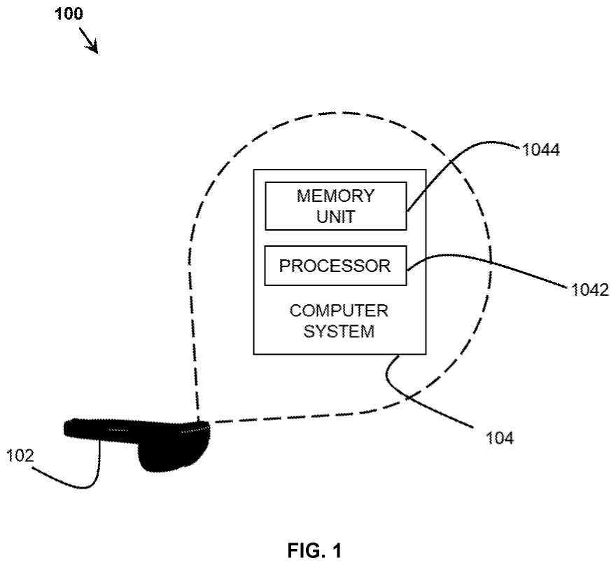

FIG. 1 illustrates an exemplary environment of computing devices to which the various embodiments described herein may be implemented, in accordance with an embodiment of the present invention.

As shown in FIG. 1, the environment (100) comprises a display means connected with a computer system (104). The display means may be, but not limited to, a Head Mounted Device (HMD) (102) or a computing means having a display screen such as a laptop, a desktop computer, mobile computer, handheld computer, a holographic display operated by users. Preferably, the display means is the HMD (102). The HMD (102) may be envisaged to include capabilities of generating an augmented reality (AR) environment, mixed reality (MR) environment and a virtual reality (VR) environment in a single device. The HMD (102) is envisaged to include, but not limited to, a number of electromagnetic radiation sensors which encompasses all kinds of sensor device able to detect electromagnetic radiation such as visible light and infra-red (IR) radiation.

The electromagnetic radiation sensors may be used to gather and track spatial data of the real-world environment as well as to track eye movement and hand gesture of a user so as to update the 3D generated object in VR, AR and/or MR. The electromagnetic radiation sensors may have an IR projector, an IR camera, an RGB camera, an RGB-D camera, a microphone. RGB camera captures coloured imagery of the real-world environment. The IR projector and IR camera together capture depth data of the real-world environment using any one or more of Time of Flight based and passive stereoscopic depth imaging.

The microphone is envisaged to receive and record audio. The HMD (102) may further comprise visors of may be partially or fully reflective surface. In other words, the visors may have a variable transparency. The visors are used to view human or object in virtual reality, mixed reality or augmented reality. The HMD (102) may further include cooling vent to ensure that internal circuitry and devices of the HMD (102) are provided with enough amount of air for convection cooling. A wire outlet may be provided to allow the connecting wires and chords to connect to various components such as power supply, computational and control units and data acquisition devices.

Further, the HMD (102) is envisaged to include extendable bands and straps and a strap lock for securing the HMD (102) positioned on the head. The HMD (102) is envisaged to include one or more display sources which may be LCD, LED or TFT screens with respective drivers. The HMD (102) may have a driver board including a part of computational software and hardware needed to run devices provided with the HMD (102). The HMD (102) may further include power supply unit for receiving AC power supply. Moreover, the HMD (102) may include, HDMI output to allow data to be transferred. A Universal serial bus (USB) connector to allow data and power transfer. The HMD (102) is also envisaged to include a plurality of electronic components for example, a graphics processor unit (GPU) and a power source provide electrical power to the HMD (102).

A Graphics Processing Unit (GPU) is a single-chip processor primarily used to manage and boost the performance of video and graphics such as 2-D or 3-D graphics, texture mapping, hardware overlays etc. The GPU may be selected from, but not limited to, NVIDIA, AMD, Intel and ARM for real time 3D imaging. The power source may be inbuilt inside the HMD (102). A plurality of indicators such as LED to indicate various parameters such as battery level or connection disconnection may be included in the HMD (102). The indications may be colour coded for differentiation and distinctiveness.

In accordance with an embodiment, the computer system (104) connected with the HMD (102), may be encased inside the HMD (102) itself. The computer system (104) is comprises a memory unit (1044) configured to store machine-readable instructions. The machine-readable instructions may be loaded into the memory unit (1042) from a non-transitory machine-readable medium, such as, but not limited to, CD-ROMs, DVD-ROMs and Flash Drives. Alternately, the machine-readable instructions may be loaded in a form of a computer software program into the memory unit (1042). The memory unit (1042) in that manner may be selected from a group comprising EPROM, EEPROM and Flash memory. Further, the computer system (104) includes a processor (1044) operably connected with the memory unit (1042). In various embodiments, the processor (1044) is one of, but not limited to, a general-purpose processor, an application specific integrated circuit (ASIC) and a field-programmable gate array (FPGA).

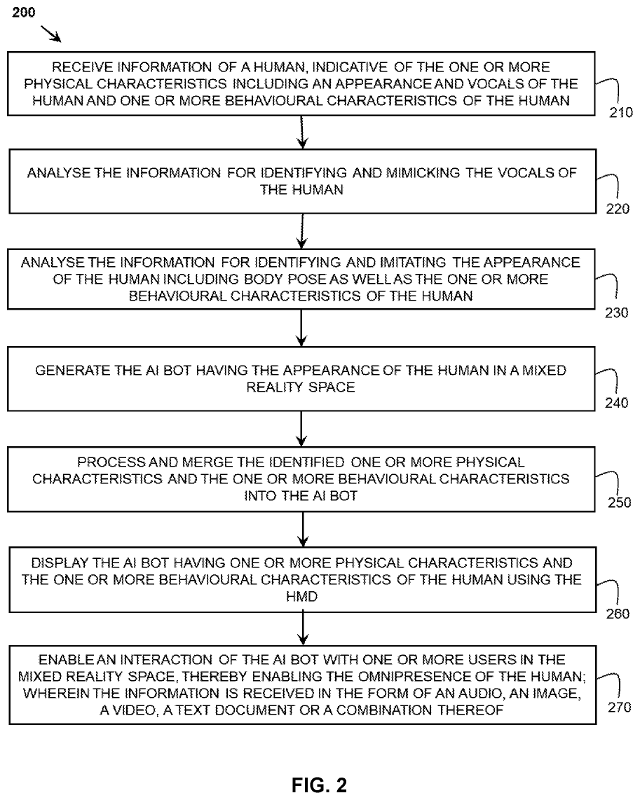

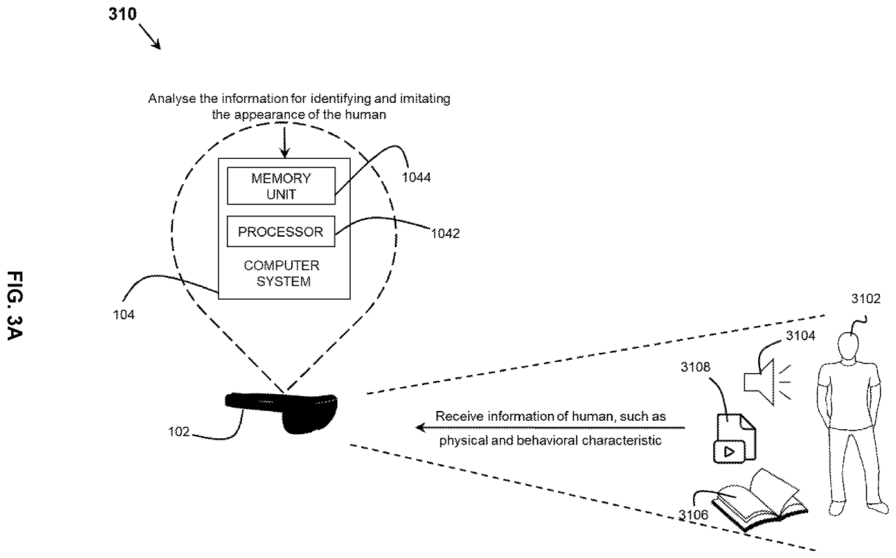

FIG. 2 is a method (200) for generating and displaying an Artificial Intelligence (AI) bot capable of analysing and mimicking human behaviour, in accordance with an embodiment of the present invention. The method (200) begins at step 210, when the processor (1044) receives information of a human. The same has been illustrated in FIG. 3A. The information may be indicative of one or more behavioural characteristics of the human (3102). The one or more behavioural characteristics may comprise a thought process, reactions in predetermined situations and mannerisms including a way of walking, sitting, sprinting, eating, interaction with people, performance of daily chores and daily life objects.

The information may also indicate one or more physical characteristics including an appearance and vocals of the human (3102) The information is received in the form of an audio (3104), an image (not shown), a video (3108), a text document (3106) or a combination thereof. The text document (3106) is a printed document and/or handwritten document configured to be analysed using Optical Character Recognition (OCR) for identifying and imitating the one or more physical characteristics and the one or more behavioural characteristics from the text. The information in the form of text documents are selected from a group comprising a biography, an autobiography, transcripts, handwritten manuscripts and published articles describing the human (3102). Further, in one embodiment, any additional information or any missing information related to the one or more physical characteristics and the one or more behavioural characteristics may be acquired from internet. The audio (3104) information of the human may be received in the form of an audiobook, a recorded audio and/or an audio received using one or more microphone of the HMD (102). The video (3108) information of the human is received in the form a movie, a recorded video and/or a visual input received using one or more cameras of the HMD (102). Consider an example of a great musician like such as Jimi Hendrix. The processor may receive a biography (text document) of Jimi Hendrix along with a video. The one or more physical characteristics and the one or more behavioural characteristics of Jimi Hendrix like how he used to play guitar, walk, talk, interact, his emotional intelligence and personal life information may be attributed from the written text in the biography and the video.

Yet another example may be of a living personality. The processor (1044) may be able to receive the information of human indicative of the one or more physical characteristics including an appearance and vocals of the human and one or more behavioural characteristics of the human through a live feed or audio visual and/or text input by means of cameras and sensors incorporated in the HMD (102).

Then, at step 220, the processor (1044) is configured to analyse the information received at step 210, for identifying and mimicking the vocals of the human (3102). The processor (1044) is envisaged to include capabilities to mimic a particular human's voice by listening for some duration of time. The present invention is envisaged to implement artificial intelligence and machine learning technologies. Referring back to the above example, audio and/or visuals that were input along with biography of Jimi Hendrix are analysed and the processor (1044) is configured to learn and mimic the voice of Jimi Hendrix over time. The same has been illustrated in FIG. 3A.

After that, at step 230, the processor (1044) is configured to analyse the information for identifying and imitating the appearance of the human (3102). The appearance includes, but not limited to, a body pose as well as the one or more behavioural characteristics of the human. At this step, the processor (1044) is configured to identify a plurality of facial landmarks from a face of the human (3102). In accordance with an embodiment of the present invention, cameras and sensors incorporated in the HMD (102) may capture facial landmarks of human (3102) from an image or from a video. Further, the body pose of the human (3102) is estimated using the body pose estimation. The present invention uses state of the art 6DOF Human Body Pose estimation and facial expression detection technologies to estimate body posture and facial expressions.

Referring to the above-mentioned example, a video and audio may provide the posture in which Jimi Hendrix used to stand, sit, greet or walk etc. Further, the system (100) in configured to identify a plurality of coordinates indicative of movement of the human (3102), thereby capturing the motion of the human (3102). The way of motion of body, reaction of body to an action, behaviour etc. may be received through a video (3108) and audio (3104). Furthermore, the behaviour may also be analysed from text document (3106) that may be provided in PDF form through USB or any other input means. For example: The text document may include excerpts portraying various situations faced by the human (3102) and how he/she behaved and went through those times. These identified one or more physical characteristics and the one or more behavioural characteristics are captured by the processor (1044).

Furthermore, at step 240, the processor (1044) is configured to generate the AI bot having the appearance of the human in a mixed reality space (324) and at step 250, the processor (1044) is configured to process and merge the identified one or more physical characteristics and the one or more behavioural characteristics into the generated AI bot. The same has been illustrated in FIG. 3B. Returning to the previous example, the physical characteristics and/or behavioural characteristics such as way of talking, way of walking, reaction to an action, facial expression etc. of Jimi Hendrix may be incorporated in the generated AI bot.

At step 260, the processor (1044) is configured to display the AI bot (324) having one or more physical characteristics and the one or more behavioural characteristics of the human using the HMD (102) preferably in a mixed reality space (322). The AI bot (324) has an appearance of the human (3102) with physical characteristics and/or behavioural characteristics such as way of talking, way of walking, facial expression etc. In accordance with an embodiment of the present invention, in case when the display means is a laptop, desktop PC or handheld computers, then the AI bot is visible in the display screen of the laptop, desktop PC or handheld computers in 2D. In accordance with another embodiment of the present invention, in case when the display means is a holographic display, then the AI bot is visible in the holographic space in 3D. Preferably, the present invention uses the HMD (102) and the AI bot (324) is displayed in the mixed reality space (322).

At step 270, The processor (1044) is configured to enable an interaction of the AI bot (324) with one or more users in the mixed reality space. The interaction may include, but not limited to, having a conversation and teaching lessons with the AI bot (324) in the MR space (322). For example, a user may interact with the AI bot of the Jimi Hendrix generated in previous steps, such as answering any question of about the life or other information that was received as input in the form of audio (3104), video (3108), text document (3106) or images.

In case of the HMD (102) and holographic display, the interaction may be enabled by vocal inputs such as asking a question, gestures etc. Whereas in case of the laptop, desktop PC or handheld computers, the interaction may be enabled by, but not limited to, vocal inputs such as asking a question, touch-based inputs or input via keypads/keyboards.

In one embodiment of the present invention, the AI bot (324) may be trained to learn specific skill(s). For example, the AI bot (324) may be trained to learn and teach guitar playing, cooking, public speaking etc. In one embodiment of the present invention, any specific skill(s) may be provided to the AI bot (324) irrespective of whether the human (3102) (alive or dead) whose AI bot (324) is being generated, had those specific skills or not. Furthermore, the AI bot (324) may be trained to have spatial awareness of the one or more objects (such as tables, chairs, walls, lighting) present in the mixed reality space. the AI bot (324) when giving a lecture to a student in student's house can sense the various objects in the room, can move around the obstacles and can sit on an appropriate real surface.

In accordance with an embodiment of the present invention, the processor (1044) is envisaged to have machine learning capabilities that enable to improve the imitation, mimicry and behaviour of artificial intelligence (AI) bot (324) with time even after the AI bot (324) is generated. Further, the specific skills of the AI bot (324) may also be improved with time by gathering the information frequently from the internet. Continuing from the above example, the AI bot (324) generated may improve the specific skills relating to the guitar using the information (audio, video, document etc.) from the internet. In simple terms, if the AI bot (324) is at a beginner skill level of guitar skills at a time, then with time the AI bot (324) may improve to an intermediate or an advanced skill level. Also, if a user queries about something that the AI bot (324) does not know at the time of questioning, so it may learn the required skill and after some time teach the same, if and when, the user queries. It will be appreciated by the person skilled in the art that with time, the skill level of the AI bot (324) may improve to higher level than the original skill level of the human (3102) (alive or dead) whose AI bot (324) has been generated.

In accordance with an embodiment of the present invention, the processor (1044) is envisaged to have artificial intelligence capabilities to predict the one or more physical and the one or more behavioural characteristics such as appearance, way of walking, talking, voice etc. of the human (3102) (dead/alive) whose bot has been generated, at different ages of life and incorporate the same in the generated AI bot (324). Additionally, may processor (1044) enable tweaking of one or more physical and the one or more behavioural characteristics of the generated AI bot (324) to make it better than the human (3102) whose AI bot (324) has been generated. For example, the AI bot (324) can be made more confident with more fluent speech compared to the human (3102).

In accordance with an embodiment of the present invention, once the AI bot (324) is generated, multiple users may access and interact with the AI bot (324) on the respective display means. In other words, the AI bot (324) may be interacting with more than one user at the same time, thereby enabling omnipresence of a human (3102). For example: if an AI bot is generated of person who has specific skills such as being good in academics, music, games, cooking etc., then the AI bot of that human may be teaching academics to one user, talking about music and games to another user and giving cooking lesson to yet another user, all at the same time accessing through the respective display units. The display units, as previously discussed may be the HMD, laptop, desktop PC, handheld computers, holographic display etc. Preferably, the display unit is the HMD (102) for the present invention

The AI bot (324) may interact with the respective users in a chosen language by the user. The interaction with the users may be available in multiple languages including sign languages. Using this capability any AI bot (324) is inherently multi-lingual. Not only can AI bot (324) be trained in any language, it can train using one language but teach the same skills to any other user using a different language, still keeping the voice, mannerisms and gestures (physical and behavioural characteristics) same as the primary user.

Further, the AI bot (324) may teach and train the specific skills to the users individually or in group. Further the AI bot (324) may answer questions, hold conversations with the users. In one embodiment of the present invention, the processor may be configured to remove explicit content from the information. Further, the AI bot (324) may be forbidden from learning or replying to any explicit content asked by the users. For example, if the user asks immoral questions from the AI bot (324), the AI bot (324) may not answer to such questions.

Furthermore, the AI bot (324) may be configured to include emotional intelligence of the human (3102) (who AI bot (324) has been or is being generated). The emotional intelligence may also improve with time based on user interactions and experiences. During the interactions with the human (3102) himself/herself or others, the AI bot (324) may also share human-like emotional and experiential feedback with the human (3102) which might be helpful for enrichment of the attributes and skillsets of the human whose digital manifestation or AI bot was initially created.

Furthermore, the AI bot (324) may collect information from various interactions with different users to process it and give a human (3102) understandable and organic feedback to the human whose AI bot (324) has been created. This might help in the enrichment of the skillset and attributes of the same human (3102).

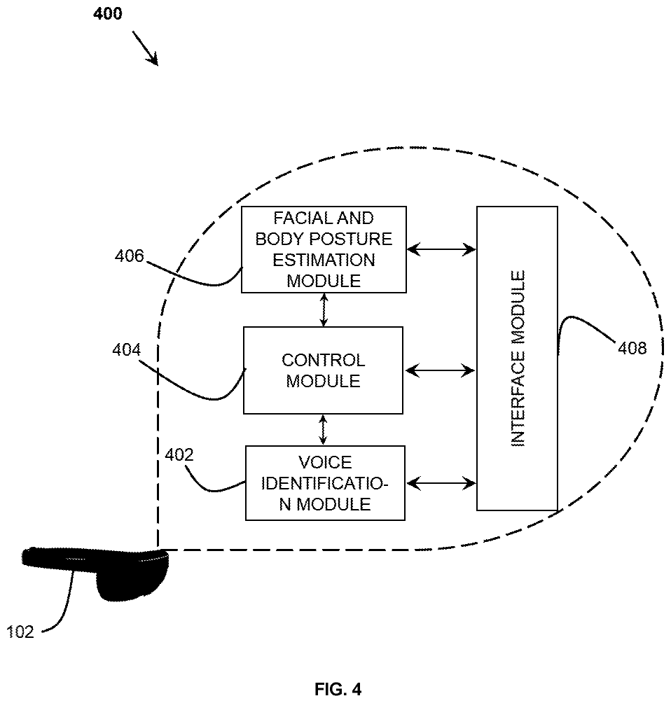

According to another aspect of the invention, there is provided a system for generating an Artificial Intelligence (AI) bot capable of analysing and mimicking human behaviour (dead/alive), illustrated in FIG. 5. As shown in FIG. 5, the system (400) may comprise a control module (404) connected with the display means (not shown). The display means may be, but not limited to, a Head Mounted Device (HMD) (102) or a computing means having a display screen such as a laptop, a desktop computer, mobile computer, handheld computer, a holographic display operated by users. Preferably, the display means is the HMD (102).

The system (400) further comprises an interface module (408), a voice identification module (402) and a facial and body posture estimation module (406). The control module (404) is envisaged to include computing capabilities such as a memory unit (not shown) configured to store machine readable instructions. The machine-readable instructions may be loaded into the memory unit from a non-transitory machine-readable medium such as, but not limited to, CD-ROMs, DVD-ROMs and Flash Drives. Alternately, the machine-readable instructions may be loaded in a form of a computer software program into the memory unit. The memory unit in that manner may be selected from a group comprising EPROM, EEPROM and Flash memory.

Further, the control module (404) includes a processor or plurality of high-speed computing processors with multiple cores (not shown) operably connected with the memory unit. In various embodiments, the processor is one of, but not limited to, a general-purpose processor, an application specific integrated circuit (ASIC) and a field-programmable gate array (FPGA). Additionally, the interface module (408) may be configured to receive information of a human, indicative of the one or more physical characteristics including an appearance and vocals of the human and one or more behavioural characteristics of the human. The one or more behavioural characteristics comprise a thought process, reactions in predetermined situations and mannerisms including a way of walking, sitting, sprinting, eating, interaction with people, performance of daily chores and daily life objects.

Further, the voice identification module (402) may be configured to analyse the information for identifying and mimicking the vocals of the human. The facial and body posture estimation module (406) analyse the information for identifying and imitating the appearance of the human including body pose as well as the one or more behavioural characteristics of the human. Further, the facial and body posture estimation module (406) may be configured to identify a plurality of facial landmarks from a face of the human. Further, the facial and body posture estimation module (406) may estimate a body pose of the human using the body pose estimation and identify a plurality of coordinates indicative of movement of the human, thereby capturing the motion of the human. The information may be received in the form of an audio, an image, a video, a text document or a combination thereof.

The text document may be a printed document and/or handwritten document configured to be analysed using Optical Character Recognition (OCR) for identifying and imitating the one or more physical characteristics and the one or more behavioural characteristics from the text. The information in the form of text documents are selected from a group comprising a biography, an autobiography, transcripts, handwritten manuscripts and published articles describing the human. The audio information of the human may be received in the form of an audiobook, a recorded audio and/or an audio received using one or more microphones of the HMD (102). The video information of the human is received in the form of a movie, a recorded video and/or a visual input received using one or more cameras of the HMD (102).

The control module (404) is configured to generate the AI bot having the appearance of the human in a mixed reality space. Further, control module (404) is configured to process and merging the identified one or more physical characteristics and the one or more behavioural characteristics into the AI bot. The HMD (102) may be configured to display the AI bot having one or more physical characteristics and the one or more behavioural characteristics of the human using the HMD (102). The HMD (102) may be further configured to enable an interaction of the AI bot with one or more users in the mixed reality space, thereby enabling the omnipresence of the human.

Moreover, in accordance with an embodiment of the present invention, the system (400) is envisaged to include machine learning function which may enable the system to improve the system and the method for generating a head mounted device based augmented artificial intelligence (AI) bot with time depending on input provided to the system. Further, the system is improved with time by gathering the information frequently from the internet.

The computer systems, methods and system disclosed in the present invention implement a lot of data privacy, data ownership and data censorship clauses and methods in which all the new censored data collected by the AI bot while interacting with multiple users and the capabilities learnt from these interactions is the ownership of the user generating the AI bot.

The present invention and the method offer a number of advantages, the present technology extends the presence of humans as an omnipresent virtual entity across the globe. It aims to elevate human visual perception towards sensing the presence of a human through existing augmented reality interfaces. The technology will allow humans to communicate seamlessly without sensing the barriers of technology. The presence of such a technology will allow humans to virtually place themselves before anyone within real-time scenarios. The technology can be sought as revolutionising the entire human generation by bringing into existence the most famous theory of Quantum Teleportation in the history of science.

Further, one would appreciate that a communication network may also be used in the system. The communication network can be a short-range communication network and/or a long-range communication network, wire or wireless communication network. The communication interface includes, but not limited to, a serial communication interface, a parallel communication interface or a combination thereof.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publicly accessible network such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention.

We claim:

1. A method (200) for generating an Artificial Intelligence (AI) bot capable of analysing and mimicking human (3102) behaviour (dead/alive) using a Mixed Reality (MR) based Head Mounted Device (HMD) (102), the method comprising the steps of:
receiving (210) information of a human (3102), indicative of the one or more physical characteristics including an appearance and vocals of the human (3102) and one or more behavioural characteristics of the human (3102);
analysing (220) the information for identifying and mimicking the vocals of the human (3102);
analysing (230) the information for identifying and imitating the appearance of the human (3102) including body pose as well as the one or more behavioural characteristics of the human (3102);
generating (240) the AI bot having the appearance of the human (3102) in a mixed reality space;
processing and merging (250) the identified one or more physical characteristics and the one or more behavioural characteristics into the AI bot;
displaying (260) the AI bot having one or more physical characteristics and the one or more behavioural characteristics of the human (3102) using the HMD (102);
enabling (270) an interaction of the AI bot with one or more users in the mixed reality space, thereby enabling the omnipresence of the human (3102);
wherein the information is received in the form of an audio (3104), an image, a video (3108), a text document (3106) or a combination thereof;
wherein the text document (3106) is a printed document and/or handwritten document configured to be analysed using Optical Character Recognition (OCR) for identifying and imitating the one or more physical characteristics and the one or more behavioural characteristics from the text.

2. The method (200) as claimed in claim 1, wherein the human (3102) is a dead person or an alive person.

3. The method (200) as claimed in claim 1, wherein the one or more behavioural characteristics comprise a thought process, reactions in predetermined situations and mannerisms including a way of walking, sitting, sprinting, eating, interaction with people, performance of daily chores and daily life objects.

4. The method (200) as claimed in claim 1, wherein the audio (3104) information of the human (3102) is received in the form of an audiobook, a recorded audio and/or an audio received using one or more microphone of the HMD (102).

5. The method (200) as claimed in claim 1, wherein the video (3108) information of the human (3102) is received in the form a movie, a recorded video and/or a visual input received using one or more cameras of the HMD (102).

6. The method (200) as claimed in claim 1, wherein the information in the form of text documents (3106) are selected from a group comprising a biography, an autobiography, transcripts, handwritten manuscripts and published articles describing the human (3102).

7. The method (200) as claimed in claim 1, wherein the step of analysing (230) the information for identifying and imitating the appearance of the human (3102) further comprising the steps of:
identifying a plurality of facial landmarks from a face of the human;
a body pose estimation of the human (3102); and
identifying a plurality of coordinates indicative of movement of the human (3102), thereby capturing the motion of the human (3102).

8. The method (200) as claimed in claim 1, wherein the AI bot (324) generated is configured to gather additional information of the human (3102) from internet.

9. The method (200) as claimed in claim 8, further comprising a step of detecting and censoring explicit information in the form of the audio (3104), the image, the video (3108), the text document (3106) from the internet or user interaction, thereby preventing the AI bot (324) from learning such information or answer user queries involving the explicit information.

10. The method (200) as claimed in claim 1, wherein the AI bot generated is configured to learn and teach specific skills and continuously improve the learnt specific skills with time, using the information from the internet based on user feedback and cues.

11. The method (200) as claimed in claim 1, further comprising a step of predicting the one or more physical and the one or more behavioural characteristics of the human (3102) (dead/alive) whose bot has been generated, at different ages of life and incorporate the same in the generated AI bot (324).

12. The method (200) as claimed in claim 1, further comprising a step of tweaking of one or more physical characteristics and the one or more behavioural characteristics of the generated AI bot (324) to make the AI bot (324) better than the human (3102) whose AI bot (324) has been generated.

13. The method (200) as claimed in claim 1, wherein the AI bot (324) generated is configured to learn and interact in one or more languages while keeping the one or more physical characteristics and the one or more behavioural characteristics of the human (3102).

14. The method (200) as claimed in claim 1, wherein the AI bot (324) generated is configured with spatial awareness of the one or more objects present in the mixed reality space.

15. The method (200) as claimed in claim 1, wherein the AI bot (324) is configured with an emotional intelligence of the human (3102) whose AI bot (324) is being generated so that the AI bot can interact in a human-like intelligent and organic way with other users.

16. The method (200) as claimed in claim 1, wherein AI bot (324) is configured to collect information from various interactions with different users to process it and give a human (3102) understandable and organic feedback to the human whose AI bot (324) has been created, thereby helping in the enrichment of the skillset and attributes of the same human (3102).

17. The method (200) as claimed in claim 1, further comprising a step of implementing data privacy, data ownership and data censorship clauses and procedures to ensure that all the new censored data collected by the AI bot (324) while interacting with multiple users and the capabilities learnt from the interactions is the ownership of the user generating the AI bot (324).

18. A computer system (104) for generating an Artificial Intelligence (AI) bot capable of analysing and mimicking human (3102) behaviour (dead/alive) using a Mixed Reality (MR) based Head Mounted Device (HMD (102)), the computer system (104) being connected with the MR based HMD (102), the computer system (104) comprising:
a memory unit (1042) configured to store machine-readable instructions; and
a processor operably connected with the memory unit (1042), the processor obtaining the machine-readable instructions from the memory unit (1042), and being configured by the machine-readable instructions to:
receive information of a human (3102), indicative of the one or more physical characteristics including an appearance and vocals of the human (3102) and one or more behavioural characteristics of the human (3102);
analyse the information for identifying and mimicking the vocals of the human (3102);
analyse the information for identifying and imitating the appearance of the human (3102) including body pose as well as the one or more behavioural characteristics of the human (3102);
generate the AI bot having the appearance of the human (3102) in a mixed reality space;
process and merging the identified one or more physical characteristics and the one or more behavioural characteristics into the AI bot;
display the AI bot having one or more physical characteristics and the one or more behavioural characteristics of the human (3102) using the HMD (102);
enable an interaction of the AI bot with one or more users in the mixed reality space, thereby enabling the omnipresence of the human (3102);
wherein the information is received in the form of an audio (3104), an image, a video (3108), a text document (3106) or a combination thereof;
wherein the text document is a printed document and/or handwritten document configured to be analysed using Optical Character Recognition (OCR) for identifying and imitating the one or more physical characteristics and the one or more behavioural characteristics from the text.

19. The computer system (104) as claimed in claim 18, wherein the human (3102) is a dead person or an alive person.

20. The computer system (104) as claimed in claim 18, wherein the one or more behavioural characteristics comprise a thought process, reactions in predetermined situations and mannerisms including a way of walking, sitting, sprinting, eating, interaction with people, performance of daily chores and daily life objects.

21. The computer system (104) as claimed in claim 18, wherein the audio (3104) information of the human (3102) is received in the form of an audiobook, a recorded audio and/or an audio received using one or more microphone of the HMD (102).

22. The computer system (104) as claimed in claim 18, wherein the video (3108) information of the human (3102) is received in the form a movie, a recorded video and/or a visual input received using one or more cameras of the HMD (102).

23. The computer system (104) as claimed in claim 18, wherein the information in the form of text documents (3106) are selected from a group comprising a biography, an autobiography, transcripts, handwritten manuscripts and published articles describing the human (3102).

24. The computer system (104) as claimed in claim 18, wherein for analysing (230) the information for identifying and imitating the appearance of the human (3102), the processor is configured to:
identify a plurality of facial landmarks from a face of the human (3102);
estimate a body pose of the human (3102) using the body pose estimation; and
identify a plurality of coordinates indicative of movement of the human (3102), thereby capturing the motion of the human (3102).

25. The computer system (104) as claimed in claim 18, wherein the AI bot (324) generated is configured to gather additional information of the human (3102) from internet.

26. The computer system (104) as claimed in claim 18, wherein the processor (1044) is configure to detect and censor explicit information in the form of the audio (3104), the image, the video (3108), the text document (3106) from the internet or user interaction, thereby preventing the AI bot (324) from learning such information or answer user queries involving the explicit information.

27. A system (400) for generating an Artificial Intelligence (AI) bot capable of analysing and mimicking human (3102) behaviour (dead/alive) using a Mixed Reality (MR) based Head Mounted Device (HMD) (102), the system comprising:
a control module (404) connected with the HMD (102);
an interface module (408);
a voice identification module (402); and
a facial and body posture estimation module (406);
wherein the interface module (408) is configured to:
receive information of a human (3102), indicative of the one or more physical characteristics including an appearance and vocals of the human (3102) and one or more behavioural characteristics of the human (3102);
wherein the voice identification module (402) is configured to analyse the information for identifying and mimicking the vocals of the human (3102);
wherein the facial and body posture estimation module (406) analyse the information for identifying and imitating the appearance of the human (3102) including body pose as well as the one or more behavioural characteristics of the human (3102);
wherein the control module (404) is configured to:
generate the AI bot having the appearance of the human (3102) in a mixed reality space;
process and merging the identified one or more physical characteristics and the one or more behavioural characteristics into the AI bot;
wherein the HMD (102) is configured to:
display the AI bot having one or more physical characteristics and the one or more behavioural characteristics of the human (3102) using the HMD (102);
enable an interaction of the AI bot with one or more users in the mixed reality space, thereby enabling the omnipresence of the human (3102);
wherein the information is received in the form of an audio (3104), an image, a video (3108), a text document (3106) or a combination thereof;
wherein the text document (3106) is a printed document and/or handwritten document configured to be analysed using Optical Character Recognition (OCR) for identifying and imitating the one or more physical characteristics and the one or more behavioural characteristics from the text.

28. The system (400) as claimed in claim 27, wherein the human (3102) is a dead person or an alive person.

29. The system (400) as claimed in claim 27, wherein the one or more behavioural characteristics comprise a thought process, reactions in predetermined situations and mannerisms including a way of walking, sitting, sprinting, eating, interaction with people, performance of daily chores and daily life objects.

30. The system (400) as claimed in claim 27, wherein the audio (3104) information of the human (3102) is received in the form of an audiobook, a recorded audio and/or an audio received using one or more microphones of the HMD (102).

31. The system (400) as claimed in claim 27, wherein the video information of the human (3102) is received in the form a movie, a recorded video and/or a visual input received using one or more cameras of the HMD (102).

32. The system (400) as claimed in claim 27, wherein the information in the form of text documents (3106) are selected from a group comprising a biography, an autobiography, transcripts, handwritten manuscripts and published articles describing the human (3102).

33. The system (400) as claimed in claim 27, wherein the facial and body posture estimation module (406) is configured to:
identify a plurality of facial landmarks from a face of the human (3102);
estimate a body pose of the human (3102) using the body pose estimation; and
identify a plurality of coordinates indicative of movement of the human (3102), thereby capturing the motion of the human (3102).

34. The system (400) as claimed in claim 27, wherein the AI bot (324) generated is configured to gather additional information of the human (3102) from internet.

35. The system (400) as claimed in claim 27, wherein the processor (1044) is configure to detect and censor explicit information in the form of the audio (3104), the image, the video (3108), the text document (3106) from the internet or user interaction, thereby preventing the AI bot (324) from learning such information or answer user queries involving the explicit information.

36. A method for generating and displaying an Artificial Intelligence (AI) bot capable of analysing and mimicking human behaviour (dead/alive), the method comprising the steps of:
receiving information of a human, indicative of the one or more physical characteristics including an appearance and vocals of the human and one or more behavioural characteristics of the human;
analysing the information for identifying and mimicking the vocals of the human;
analysing the information for identifying and imitating the appearance of the human including body pose as well as the one or more behavioural characteristics of the human;
generating the AI bot having the appearance of the human in a mixed reality space;
processing and merging the identified one or more physical characteristics and the one or more behavioural characteristics into the AI bot;
displaying the AI bot having one or more physical characteristics and the one or more behavioural characteristics of the human on a display means;
enabling an interaction of the AI bot with one or more users in the mixed reality space, thereby enabling the omnipresence of the human;
wherein the information is received in the form of an audio, an image, a video, a text document or a combination thereof;
wherein the text document is a printed document and/or handwritten document configured to be analysed using Optical Character Recognition (OCR) for identifying and imitating the one or more physical characteristics and the one or more behavioural characteristics from the text.

37. The method as claimed in claim 36, wherein the human is a dead person or an alive person.

38. The method as claimed in claim 36, wherein the one or more behavioural characteristics comprise a thought process, reactions in predetermined situations and mannerisms including a way of walking, sitting, sprinting, eating, interaction with people, performance of daily chores and daily life objects.

39. The method as claimed in claim 36, wherein the audio information of the human is received in the form of an audiobook, a recorded audio and/or an audio received using one or more microphone.

40. The method as claimed in claim 36, wherein the video information of the human is received in the form a movie, a recorded video and/or a visual input received using one or more cameras.

41. The method as claimed in claim 36, wherein the information in the form of text documents are selected from a group comprising a biography, an autobiography, transcripts, handwritten manuscripts and published articles describing the human.

42. The method as claimed in claim 36, wherein the step of analysing the information for identifying and imitating the appearance of the human further comprising the steps of:
identifying a plurality of facial landmarks from a face of the human;
a body pose estimation of the human; and
identifying a plurality of coordinates indicative of movement of the human, thereby capturing the motion of the human.

43. The method as claimed in claim 36, wherein the display means is selected from a group comprising a Head Mounted Device (HMD) or a computing means having a display screen such as a laptop, a desktop computer, mobile computer, handheld computer and a holographic display.

44. A computer system for generating and displaying an Artificial Intelligence (AI) bot capable of analysing and mimicking human behaviour (dead/alive) using a display means, the computer system comprising:
a memory unit configured to store machine-readable instructions; and
a processor operably connected with the memory unit, the processor obtaining the machine-readable instructions from the memory unit, and being configured by the machine-readable instructions to:
receive information of a human, indicative of the one or more physical characteristics including an appearance and vocals of the human and one or more behavioural characteristics of the human;
analyse the information for identifying and mimicking the vocals of the human;
analyse the information for identifying and imitating the appearance of the human including body pose as well as the one or more behavioural characteristics of the human;
generate the AI bot having the appearance of the human in a mixed reality space;
process and merging the identified one or more physical characteristics and the one or more behavioural characteristics into the AI bot;
display the AI bot having one or more physical characteristics and the one or more behavioural characteristics of the human using the display means;
enable an interaction of the AI bot with one or more users in the mixed reality space, thereby enabling the omnipresence of the human;
wherein the information is received in the form of an audio, an image, a video, a text document or a combination thereof;
wherein the text document is a printed document and/or handwritten document configured to be analysed using Optical Character Recognition (OCR) for identifying and imitating the one or more physical characteristics and the one or more behavioural characteristics from the text.

45. The computer system as claimed in claim 44, wherein the human is a dead person or an alive person.

46. The computer system as claimed in claim 44, wherein the one or more behavioural characteristics comprise a thought process, reactions in predetermined situations and mannerisms including a way of walking, sitting, sprinting, eating, interaction with people, performance of daily chores and daily life objects.

47. The computer system as claimed in claim 44, wherein the audio information of the human is received in the form of an audiobook, a recorded audio and/or an audio received using one or more microphone.

48. The computer system as claimed in claim 44, wherein the video information of the human is received in the form a movie, a recorded video and/or a visual input received using one or more cameras.

49. The computer system as claimed in claim 44, wherein the information in the form of text documents are selected from a group comprising a biography, an autobiography, transcripts, handwritten manuscripts and published articles describing the human.

50. The computer system as claimed in claim 44, wherein for analysing the information for identifying and imitating the appearance of the human, the processor is configured to:
identify a plurality of facial landmarks from a face of the human;
estimate a body pose of the human using the body pose estimation; and
identify a plurality of coordinates indicative of movement of the human, thereby capturing the motion of the human.

51. The computer system as claimed in claim 44, wherein the display means is selected from a group comprising a Head Mounted Device (HMD) or a computing means having a display screen such as a laptop, a desktop computer, mobile computer, handheld computer and a holographic display.

52. A system for generating and displaying an Artificial Intelligence AI bot capable of analysing and mimicking human behaviour dead/alive, the system comprising:
a computing device connected with a display means;
an interface module;
a voice identification module; and
a facial and body posture estimation module;
wherein the interface module is configured to:
receive information of a human, indicative of the one or more physical characteristics including an appearance and vocals of the human and one or more behavioural characteristics of the human;
wherein the voice identification module is configured to analyse the information for identifying and mimicking the vocals of the human;
wherein the facial and body posture estimation module analyse the information for identifying and imitating the appearance of the human including body pose as well as the one or more behavioural characteristics of the human;
wherein the computing device is configured to:
generate the AI bot having the appearance of the human in a mixed reality space;
process and merging the identified one or more physical characteristics and the one or more behavioural characteristics into the AI bot;
wherein the display means is configured to:
display the AI bot having one or more physical characteristics and the one or more behavioural characteristics of the human using the display means;
enable an interaction of the AI bot with one or more users in the mixed reality space, thereby enabling the omnipresence of the human;
wherein the information is received in the form of an audio, an image, a video, a text document or a combination thereof;
wherein the text document is a printed document and/or handwritten document configured to be analysed using Optical Character Recognition OCR for identifying and imitating the one or more physical characteristics and the one or more behavioural characteristics from the text.

53. The system as claimed in claim 52, wherein the human is a dead person or an alive person.

54. The system as claimed in claim 52, wherein the one or more physical and behavioural characteristics comprise a thought process, reactions in predetermined situations and mannerisms including a way of walking, sitting, sprinting, eating, interaction with people, performance of daily chores and daily life objects.

55. The system as claimed in claim 52, wherein the audio information of the human is received in the form of an audiobook, a recorded audio and/or an audio received using one or more microphones.

56. The system as claimed in claim 52, wherein the video information of the human is received in the form a movie, a recorded video and/or a visual input received using one or more cameras.

57. The system as claimed in claim 52, wherein the information in the form of text documents are selected from a group comprising a biography, an autobiography, transcripts, handwritten manuscripts and published articles describing the human.

58. The system as claimed in claim 52, wherein for analysing the information for identifying and imitating the appearance of the human, the facial and body posture estimation module is configured to:
identify a plurality of facial landmarks from a face of the human;
estimate a body pose of the human using the body pose estimation; and
identify a plurality of coordinates indicative of movement of the human, thereby capturing the motion of the human.

59. The system as claimed in claim 52, wherein, the display means is selected from a group comprising a Head Mounted Device (HMD) or a computing means having a display screen such as a laptop, a desktop computer, mobile computer, handheld computer and a holographic display.
